(19) United States
(12) Patent Application Publication
(10) Pub. No.: US 2010/0011969 A1
(43) Pub. Date: Jan. 21, 2010

(54) FROTHING DEVICE FOR A BEVERAGE MACHINE

(75) Inventors: Paulus C. Duineveld, Eindhoven (NL); Joeke Noordhuis, Eindhoven (NL); Fred Fraij, Eindhoven (NL); Marinus C. Hansen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,146

(22) PCT Filed: Dec. 6, 2007
(86) PCT No.: PCT/IB07/54941

§ 371 Date: Sep. 24, 2009

(30) Foreign Application Priority Data
Dec. 12, 2006 (EP) 06125931.3

(51) Int. Cl. B01F 3/04; B21D 39/04

(52) U.S. Cl. 99/323.1; 29/282

(57) ABSTRACT

A frothing device (1) is disclosed which is suited for a beverage machine. The frothing unit has an inlet (11) for a frothing medium (12) and a gas inlet (13) with an opening diameter. Furthermore, the frothing unit comprises a pumping means (14) and a tubing (15) for connecting the aforementioned components to one another. The aforementioned components form a continuous tubing system. In addition, due to the pumping action of the pumping means, a negative pressure difference with respect to the atmospheric pressure is accomplished throughout the whole tubing system.

### FIELD OF THE INVENTION

The present invention is related to a frothing device which is commonly used in a beverage machine, as for example a coffee maker.

### BACKGROUND OF THE INVENTION

In several appliances of a beverage machine, e.g. a coffee maker, a beer drafting apparatus or a cream whipping machine, it is desired to have a frothing function in the device, in order to produce froth, which is then admixed or added to the beverage.

For this purpose, gas has to be introduced into a frothing medium which is to be transported by the frothing device. Preferred gases include air, carbon dioxide, hot water steam, nitrogen and laughing gas (nitrous oxide). Preferred frothing media include milk, cream, vegetable substitutes for the latter, beer and beverages containing beer, and the like. In frothing devices according to the state of the art, which are being used for beverage machines, the gas is often introduced into the frothing medium by means of a fluid ejector pump or a pump according to the venturi pump principle. These devices are for example disclosed in EP 1462042.

These devices have in common that a single pump is used to provide the driving force for both the gas and the liquid, the latter being a vacuum pump in most cases. This means that a single pump is being used to drive either the gas or the frothing medium (i.e. fluid F1), which in turn serves as a pumping fluid for the other medium (i.e. fluid F2). This means as well that the flow rate ratio between the two fluids cannot be adjusted with help of the pump(s); instead, other mechanisms are to be applied in order to adjust the flow rate ratio.

According to devices known from the state of the art, the gas inlet opening is disposed in the wall of the tubing which connects the inlet for the frothing medium with the above-mentioned pump. Here, the gas inlet opening is always disposed in an area of the tubing where the tubing is straight, i.e. not curved or bent.

Examples for these devices are for example disclosed in U.S. Pat. No. 4,742,942, U.S. Pat. No. 4,537,332 and WO 9631125.

As the frothing quality, i.e. the quality of the froth, depends on the ratio of the frothing medium to the gas, it is important to introduce the proper amount of gas flow into the frothing device. For example, when using air to produce milk froth which is to be added to coffee beverages and the like, the air flow rate should be preferably 0.5 to 1.0 times the flow rate of the milk. For standard household and catering appliances, the flow rate of milk in the device is typically about 4-8 ml/s, which means that the flow rate of air should be in the range of 2-8 ml/s. Due to the fact that the viscosity of a gas is close to two orders of magnitude smaller than the viscosity of a liquid, it becomes obvious that the said flow rate of air is not easily kept within the said limits.

One way to control the flow rate of the air is to control the diameter of the gas inlet opening, as the flow rate I_{F} of a fluid through a circular opening is directly proportional to the area A_{O} of the opening

I_{F}˜A_{O} (1)

or to the square of the diameter D, i.e.

I_{F}˜D² (2)

The applicant has carried out respective experiments in which a jet ejector pump was used to force a gas into the frothing medium. Therein, under the provision that the above identified flow rates are to be achieved, it turned out that the gas inlet opening should not exceed 0.14 mm in diameter, in order to obtain the desired gas flow rate, and thus to obtain optimum frothing results.

As this is a very small size for standard machining, the manufacturing tolerances are becoming very important to have the proper rate of gas flow into the device. The applicant has found out experimentally that a 15% error in diameter will result in a 30% variation in gas flow, thus impairing the frothing results to an extent which is not acceptable for household and catering appliances.

In order to produce openings meeting this tolerance demands, high precision machinery is necessary, e.g. CNC lathes, laser cutting and laser ablation devices, high precision punching or drilling, which increases manufacturing costs, especially when it comes to household appliances. For catering appliances, this solution is also quite unfavorable, as here the respective tubing is often designed to be disposable for reasons of hygiene. Therefore, the tubing should be cheap in production.

Further, an opening with such diameter is prone to staining and/or constipation, particularly when a frothing medium is used which tends to decay or denaturation, as it is the case for milk and milk products, like cream. This means that these devices have to be serviced regularly in order to avoid malfunction.

WO 2006043808 and US 20040247757 disclose a frothing device wherein an adjustable valve is being used to control the gas flow rate through the gas inlet opening. This is a cost intensive solution and for that reason unattractive for the above identified household and catering appliances.

### SUMMARY OF THE INVENTION

The object of the present invention is thus to provide a frothing device suitable for being used in a beverage machine according to the above definition, which is less susceptible to clogging and congestion, and which yields a reproducible frothing result, although being manufactured with standard machinery.

This object is achieved by a frothing device and/or a method as set forth under the independent claims. The dependent claims indicate preferred embodiments. In this context it is noteworthy to mention that all ranges given in the following are to be understood as that they include the values defining these ranges.

According to the invention, a frothing device suitable for being used in a beverage machine is provided. The device comprises an inlet for a frothing medium, a gas inlet having an opening diameter, a pumping means, and a tubing connecting the aforementioned components to one another. The aforementioned components form a continuous tubing system, wherein, due to the pumping action of the pumping means, a negative pressure difference with respect to atmospheric pressure is accomplished throughout the whole tubing system. The gas inlet opening is disposed at a position in said tubing system where the pressure difference with respect to atmospheric pressure is smaller than in most other positions in said tubing system.

In this context, it is noteworthy that the amount of gas flowing through an opening is roughly proportional to the square root of the pressure difference Δ_{P} between both sides of the opening, as set forth in the following equation:

I_{F}˜\sqrt{Δp} (3);

Usually, the gas inlet opening is disposed at a linear section of the tubing, somewhere between the inlet for the frothing medium and the pumping means. Here, the pressure difference with respect to atmospheric pressure is merely dominated by the vacuum applied by the pumping means.

By disposing the gas inlet opening in the above-mentioned position it is possible to increase the opening diameter while still maintaining the gas flow on the desired level, without any further measures. Thus, a frothing device suitable for being used in a beverage machine according to the above definition can be produced, which is less susceptible to clogging and congestion, and which yields a reproducible frothing result, although being manufactured with standard machinery.

In a preferred embodiment, the device comprises a constriction in its tubing, the latter being disposed between the inlet for the frothing medium and the pumping means.

The diameter of the constriction is important, as it reduces the pressure in the tubing downstream. This determines the flow rate with which the frothing medium is pumped. Typical values for said diameter in household or catering appliances are ranging between 0.5 mm and 4 mm, and more preferably between 1 and 2 mm.

In yet another preferred embodiment, the tubing comprises a corner section characterized by an angle, an inner radius, a mean radius and an outer radius, respectively, wherein the gas inlet opening is disposed in the tubing wall, namely in the outer area of the tubing corner section.

In this context, with a tubing corner being defined by an angle α, an inner radius R_{I}, an intermediate radius R_{M} and an outer radius R_{O}, it is to be understood that the term “the outer area of the tubing corner section”, as set forth above, is the part of the tubing wall that is disposed between R_{M} and R_{O}. See FIG. 3B for a reference.

The term “corner” is to be understood in a very broad meaning. Basically, it refers to all types of tubing geometry that result in a change of direction of the main flow of >15° and <165°, and more preferably of >45° and <135°; and particularly preferably >70° and <110°. This is due to the fact that the corner does not necessarily need to make a 90° change in flow direction, as is drawn in FIG. 1.

The applicants have found out that, in a tubing corner comprising a fluid driven by a vacuum, the absolute pressure inside the tubing is different on the outer and the inner radius of the corner, i.e. the absolute pressure on the outer radius is higher than that at the inner radius; while both are still smaller than the atmospheric pressure due to the vacuum applied. This means in turn that the pressure difference with respect to the atmospheric pressure is smaller on the outer radius of the corner than on the inner radius of the corner. For this reason, when disposing the gas inlet opening of a frothing device according to the invention in the outer area of the tubing corner, the gas flowing through this opening will experience a comparatively smaller pressure difference. This in turn provides the possibility to enlarge the opening diameter of the gas inlet opening, with the advantages set forth above. The mathematical basis for these considerations, and for the above result, is given in the appendix.

More specifically, a preferred position for the gas inlet opening in the outer area of the tubing corner section is such that the distance of the opening to the point of merging of both central axes in the corner is less than 10 constriction diameters, and more preferably less than 5 constriction diameters, as can be seen from FIG. 3D.

Important variables in this context are the diameter of the constriction, as this contributes to the pressure difference with respect to the atmosphere at the position of the gas inlet opening; the length L, which is the distance between the end of the constriction to the air inlet opening; the position of the air inlet opening in the corner; and the curvature of the corner (see FIG. 3D).

With these variables one can increase the pressure with respect to the atmospheric pressure at the position of the air hole. In an embodiment of the invention, wherein the flow rate of milk is 5.5 ml/s the diameter of the constriction is 1.2 mm and the length L is 12.5 mm, a typical pressure difference with respect to atmosphere in the corner follows typically from

$$\begin{matrix}\begin{matrix}{P}_{a} - {P}_{2} = {ρ}_{\text{?}} \text{?} ( 2.3 \frac{1}{2} {V}_{2}^{2} + 1.8 \frac{1}{2} {V}_{1}^{2} ) \\ \approx 0.9 \cdot ρ \text{?} {V}_{1}^{2} \\ \approx 2.2 \cdot {10}^{4} Pa\end{matrix} \\ and & ( 4 ) \\ {V}_{c} = \frac{{Q}_{g} + Q \text{?}}{{Q}_{g}} {V}_{1} \approx 7.3 m \text{/} s \\ as & ( 5 ) \\ Δ p \approx \frac{1}{2} {p}_{\text{?}} \text{?} {V}_{1}^{2} ( 1.8 - α ( L ) {( \frac{{Q}_{g} + {Q}_{\text{?}} \text{?}}{{Q}_{g}} )}^{2} ) \\ \text{?} \text{indicates text missing or illegible when filed} & ( 6 )\end{matrix}$$

The factor α(L) is a loss factor, which is smaller than 1 and determines the actual velocity with which the liquid flows through the corner.

Q_{g} is the gas flow rate and Qₗ is the flow rate of the frothing medium. Pₐ is the atmospheric pressure, whereas P₂ is the pressure inside a straight section of the tubing. ρₗ is the density of the frothing medium. Vₗ is the velocity of the frothing medium at the constriction, and V_{c} is the velocity of the frothing medium in the corner tubing area.

The diameter of the constriction is important, as it determines the pressure difference in the corner as well as the flow rate with which the milk is pumped. Typical values for this diameter are ranging between 0.5 mm and 4 mm, and more preferably between 1 and 2 mm.

A preferred length L is typically between 0 and 30 times the diameter of the constriction, and more preferably between 5 and 15 times this diameter. When the length L becomes too long the velocity with which the liquid flows through the corner has become too small, and the pressure drop with respect to atmosphere becomes too large, resulting in a necessary smaller diameter of the gas inlet to obtain the desired flow rate.

The position of the air hole in the corner is expected to be somewhat less critical. Preferably, the center of the air hole is positioned close to where the liquid makes the Corner, i.e. close to the central line of the constriction, as is drawn in FIG. 3D. Preferably, the hole is positioned within 10 diameters of the constriction of this central line, and more preferably within 5 diameters.

Under consideration of the above, the applicant has placed a gas inlet opening in the outer area of the tubing corner section having a diameter of 0.6 mm without affecting the gas flow rate through the opening. Under experimental conditions, the reduction in pressure with respect to the atmosphere measured near the conventional position of the gas inlet opening (see position F in FIG. 2a) was about 2.2×10⁴ Pa. The reduction in pressure with respect to the atmosphere measured near the outer radius of the tubing corner section (see position E in FIG. 2A) was about 50-100 Pa, i.e. the increase of pressure (and thus the decrease in pressure difference with respect to atmospheric pressure) is substantial. This in turn accounts for the possibility to increase the diameter of the gas inlet opening, which results in the benefits as related to the manufacturing efforts and to clogging avoidance, as set forth above.

The frothing may, in another preferred embodiment, be characterized in that the gas inlet opening is disposed in the tubing wall of the inlet for the frothing medium.

This means that the gas inlet opening is disposed in the tubing wall upstream of the constriction, where the pressure is not yet reduced to the value obtained downstream of the constriction. This again leads to the same result, i.e. the pressure difference with respect to the atmospheric pressure is smaller here than elsewhere. This provides as well the possibility to enlarge the opening diameter of the gas inlet opening, with the advantages set forth above.

In an alternative embodiment of the present invention, a frothing device suitable for being used in a beverage machine is provided, comprising an inlet for a frothing medium, a gas inlet having an opening diameter, a pumping means, and a tubing connecting the aforementioned components to one another, wherein the aforementioned components form a continuous tubing system, and wherein, due to the pumping action of the pumping means, a negative pressure difference with respect to atmospheric pressure is accomplished throughout the whole tubing system. This device is characterized in that the gas inlet opening is formed in such way that the ratio between the length of the gas duct defined by the gas inlet opening and the gas inlet opening diameter is greater than 3, preferably greater than 10, more preferably greater than 100, and even more preferably greater than 400.

In this embodiment, a variation is realized which still falls under the same inventive concept as the embodiments described before as there is a technical relationship among these embodiments involving one or more of the same or corresponding special technical features, i.e. to manipulate the position of the gas inlet opening in order to allow to increase its opening diameter without affecting the gas flow rate.

According to the state of the art, the gas inlet opening is made of a very thin metal or plastic sheet. To increase the resistance in the path of the gas, while keeping the pressure difference between both sides of the gas inlet opening constant, the thickness of the sheet in which the air hole is made can for example be increased.

The higher the length LG of the gas duct defined by the gas inlet opening, the larger will the resistance for the gas flow become. Then the gas inlet opening can be increased in order to keep the gas flow rate constant.

Furthermore, a method for reducing the opening diameter of a gas inlet in a frothing device suitable for being used in a beverage machine is provided, wherein the method comprises an inlet for a frothing medium, a pumping means, and a tubing connecting the aforementioned components to one another. The aforementioned components form a continuous tubing system, and, due to the pumping action of the pumping means, a negative pressure difference with respect to atmospheric pressure is accomplished throughout the whole tubing system. The method is characterized in that the gas inlet opening is being disposed at a position in said tubing system where the pressure difference with respect to atmospheric pressure is smaller than in most other positions in said tubing system.

In a preferred embodiment of the above method, the frothing device comprises a constriction in its tubing, disposed between the inlet for the frothing medium and the pumping means.

In another preferred embodiment of the method according to the invention, the tubing comprises a corner section characterized by an angle, an inner radius, a mean radius and an outer radius, respectively, wherein the gas inlet opening is disposed in the tubing wall, namely in the outer area of the tubing corner section.

In another preferred embodiment, the gas inlet opening is disposed in the tubing wall of the inlet for the frothing medium.

In an alternative embodiment of the present invention, a method for reducing the opening diameter of a gas inlet in a frothing device suitable for being used in a beverage machine is provided, the latter comprising an inlet for a frothing medium, a gas inlet having an opening diameter, a pumping means, and a tubing connecting the aforementioned components to one another, wherein the aforementioned components form a continuous tubing system, and wherein, due to the pumping action of the pumping means, a negative pressure difference with respect to atmospheric pressure is accomplished throughout the whole tubing system. The method is characterized in that the gas inlet opening is formed in such way that the ratio between the length of the gas duct defined by the gas inlet opening and the gas inlet opening diameter is greater than 3. Preferably, said ratio is greater than 10, and more preferably greater than 20, preferably greater than 10, more preferably greater than 100, and even more preferably greater than 400.

### BRIEF DESCRIPTION OF THE DRAWINGS

Additional details, features, characteristics and advantages of the object of the invention are disclosed in the subclaims, the figures and the following description of the respective figure and examples, which, in an exemplary fashion, show preferred embodiments of a frothing device according to the invention.

FIG. 1 shows a frothing device 10 according to the invention, which is suitable for being used in a beverage machine. The device comprises an inlet 11 for a frothing medium 12, a gas inlet 13 having an opening diameter, a pumping means 14, and a tubing 15 connecting the aforementioned components to one another. The aforementioned components form a continuous tubing system. Due to the pumping action of the pumping means 14, a negative pressure difference Δ_{P} with respect to atmospheric pressure P_{A} is accomplished throughout the whole tubing system. Furthermore, the frothing device comprises a constriction 16 in its tubing 15, the latter being disposed between the inlet 11 for the frothing medium and the pumping means 14, and a tubing corner section 17.

The gas inlet opening 13 is disposed at a position in said tubing system where the pressure difference with respect to atmospheric pressure is smaller than in most other positions in said tubing system. According to the invention, this can be accomplished, for example, if the gas inlet opening is disposed in the tubing wall, namely in the outer area of the tubing corner section 17.

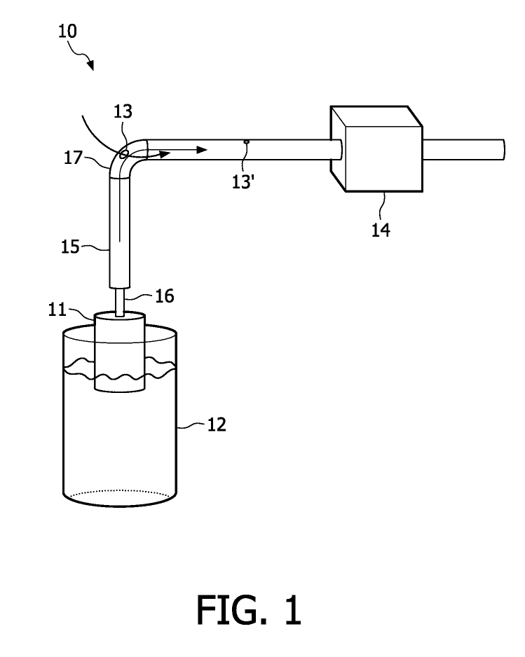

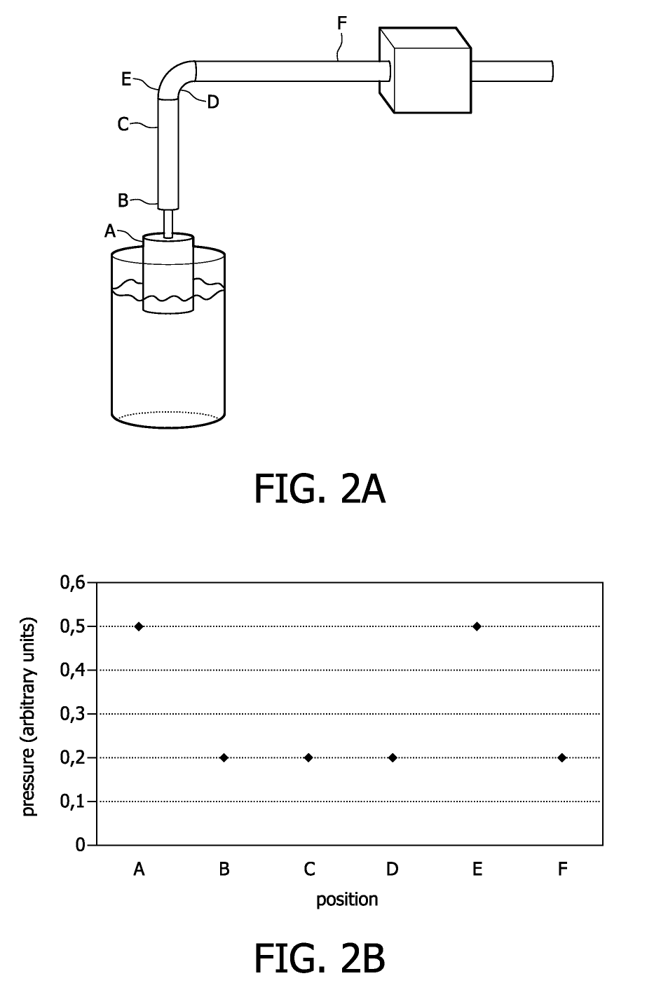

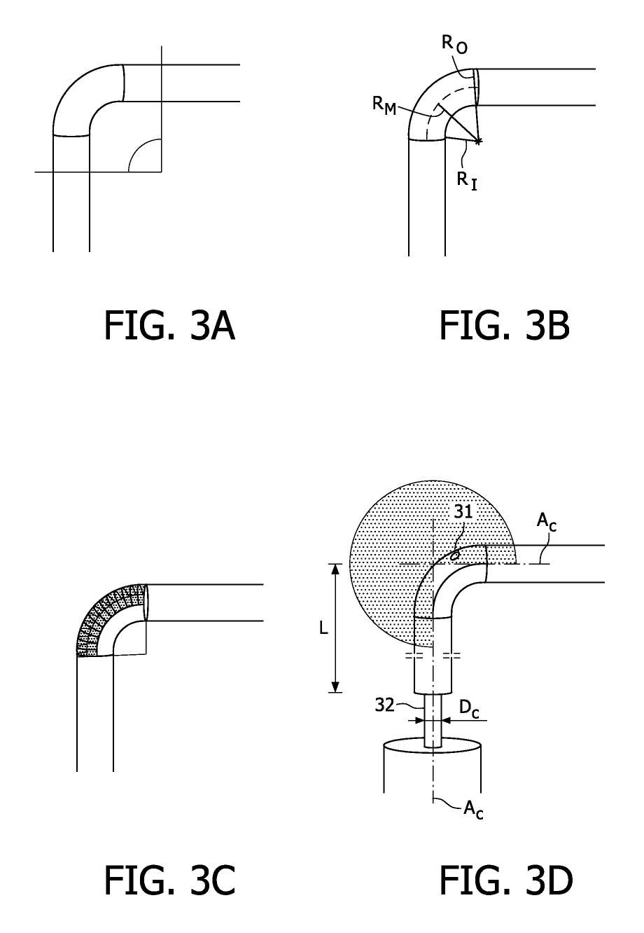

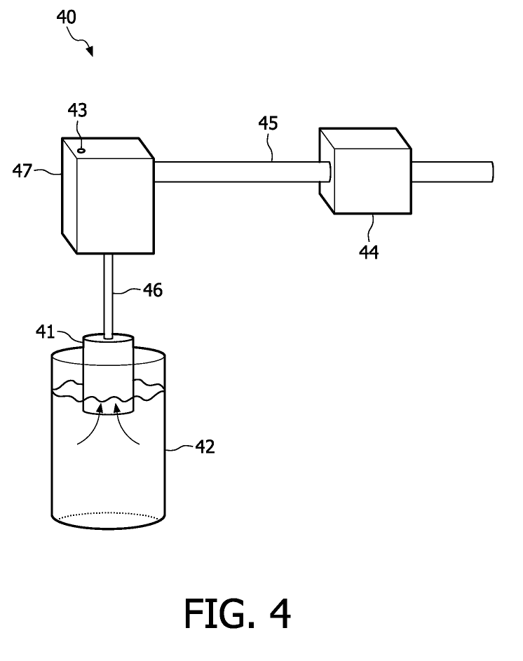

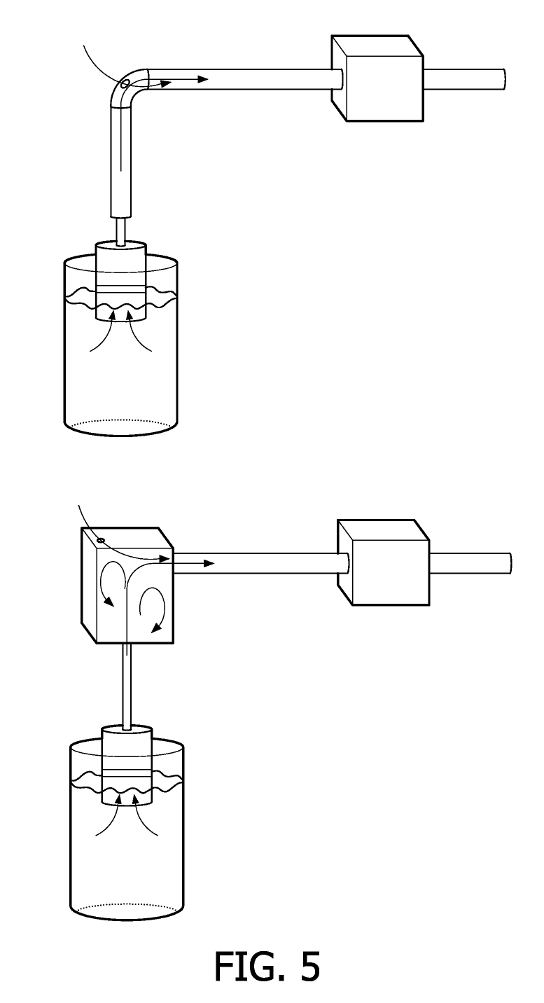

In contrast thereto, and illustrated with gray coloring in FIG. 1, in a frothing device according to the state of the art, the gas inlet opening 13′ is disposed in an area of the tubing where the tubing is straight, and where the relative pressure is smaller, thus leading to a high pressure difference with respect to the atmospheric pressure, which necessitates the use a very small diameter in the gas inlet opening, as set forth above.

FIGS. 2A and 2B show different positions in a frothing device according to the state of the art, and the relative pressure determined at these positions both theoretically and experimentally. It becomes obvious that, at positions A and E, i.e. at the inlet for the frothing medium and in the outer area of the tubing corner section, the relative pressure is higher than elsewhere; reasons for which are given above. This means in turn that the pressure difference with respect to the atmospheric pressure is smaller in these positions, thus allowing to increase the size of the gas inlet opening without affecting the gas flow rate.

FIG. 3 gives some information about the term “corner”, as it is understood in the present specification. The corner is defined by an angle α, an inner radius R_{I}, an intermediate radius R_{M} and an outer radius R_{O} (FIGS. 3A, B). The term “the outer area of the tubing corner section”, as set forth above, is to be understood as the part of the tubing wall that is disposed between R_{M} and R_{O} (shadowed area in FIG. 3C).

Different from what is shown in FIG. 3, the term “corner” comprises all types of tubing geometry that result in a change of direction of the main flow of >15° and <165°, and more preferably of >45° and <135°; and particularly preferably >70° and <110°.

In FIG. 3D it is shown that, basically, the position for the gas inlet opening in the outer area of the tubing corner section may be selected in such way that the distance of the opening to the point of merging of the central axes A_{c} in the corner is less than 10 constriction diameters D_{C}, and more preferably less than 5 constriction diameters (dark gray area), as can be seen from FIG. 3D. Exemplarily, the position of a gas inlet opening 31 is shown in FIG. 3D, as well the constriction 32. The distance between the upper end of the constriction and the gas inlet opening is defined as length L.

FIG. 4 shows a different embodiment of a frothing device 40 according to the invention. The device comprises an inlet 41 for a frothing medium 42, a gas inlet 43 having an opening diameter, a pumping means 44, a tubing 45 connecting the aforementioned components to one another, and a constriction 46 being disposed between the inlet 41 for the frothing medium and a tubing corner section 47. The gas inlet opening 43 is disposed in the outer area of the tubing corner section 47 as here the pressure difference with respect to atmospheric pressure is smaller than in most other positions in said tubing system.

The tubing corner section 47 is different from the ones described above, which merely consist of a curved or bent tubing, but in terms of angle α, inner radius R_{I}, intermediate radius R_{M} and outer radius R_{O} it still falls under the definition of a corner. The tubing corner section 47 comprises cavities, which provide recirculation areas for the frothing medium. The circulations of the frothing medium contribute to a further increase of the relative pressure in the tubing corner area, and thus to a further decrease of the pressure difference with respect to atmospheric pressure, as it is aimed for in the present invention.

FIG. 5 shows, by means of arrows, the flow of the gas and the frothing liquid in either of the above described embodiments, and the recirculations in the cavities. The latter do moreover contribute to a better mixing of the gas and the frothing liquid, thus leading to a better frothing result.

The particular combinations of elements and features in the above detailed embodiments are exemplary only; the interchanging and substitution of these teachings with other teachings in this and the patents/appliances incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

### Appendix

### Considerations on Pressure Changes Upon Flow Through a Corner

Given a situation as shown in FIG. 2 we assume that the flow is only curved in the direction as drawn. Further, the problem is simplified to investigate only a one-dimensional situation, hence outside the plane shown in FIG. 2 the situation continues to infinity. We then have that along a streamline

$${P}_{2} + \frac{1}{2} {ρ}_{\text{?}} \text{?} {V}_{2}^{2} = {P}_{1 , o} + \frac{1}{2} ρ {\text{?}}_{\text{?}} {V}_{o}^{2} = {P}_{1 , \text{?}} \text{?} + \frac{1}{2} ρ \text{?} {V}_{\text{?}}^{2} \text{?} \\ \text{?} \text{indicates text missing or illegible when filed} \qquad ( 7 )$$

From mass conservation we have

$${\int }_{{R}_{\text{?}}}^{{R}_{g}} \text{?} V ( r ) d r = Q = {V}_{2} ( {R}_{2} - R \text{?} ) \\ \text{?} \text{indicates text missing or illegible when filed} \qquad ( 8 )$$

In the corner it can be shown that due to the centripetal acceleration there is a pressure gradient necessary to drive the flow through the corner. This pressure gradient is

$$\frac{\partial P}{\partial r} = \frac{ρ \text{?} {V}^{2} ( r )}{r} \\ \text{?} \text{indicates text missing or illegible when filed} \qquad ( 9 )$$

We now introduce a simple relation for the flow in the corner as a function of radial position. We assume

$$V ( r ) = \frac{K}{r} \qquad ( 10 )$$

wherein K is a constant. From (9) and (10) it can be shown that

$${P}_{1 , o} - {P}_{1 , \text{?}} \text{?} = \frac{1}{2} ρ {\text{?}}^{2} ( \frac{1}{{R}_{1}^{2}} - \frac{1}{{R}_{2}^{2}} ) \\ \text{?} \text{indicates text missing or illegible when filed} \qquad ( 11 )$$

From (8) and (10) it can be shown that

$$K = \frac{{V}_{2} ( {R}_{2} - {R}_{1} )}{Ln ( \frac{{R}_{2}}{{R}_{1}} )} \qquad ( 12 )$$

It can be shown that we can find the exact same relation as (11), hence indeed the assumption of the velocity in the corner is of a form of (10) is correct. We can now calculate the velocity at the outer and inner position as

$${V}_{o} = \frac{{V}_{2} ( {R}_{2} - {R}_{1} )}{{R}_{2} Ln ( \frac{{R}_{2}}{{R}_{1}} )} \\ {V}_{l} = \frac{{V}_{2} ( {R}_{2} - {R}_{1} )}{{R}_{1} Ln ( \frac{{R}_{2}}{{R}_{1}} )} \qquad ( 13 )$$

With (13) and (7) it can be shown that the pressure difference is indeed as given in relation (14) and (15).

The main result is that the pressure difference in the outer radius with respect to the pressure in the main flow, P2 is given as

$${P}_{1 , o} - {P}_{2} = \frac{1}{2} {ρ}_{l} {V}_{2}^{2} ( 1 - \frac{{( {R}_{2} - {R}_{1} )}^{2}}{{{R}_{2}^{2} ( Ln [ \frac{{R}_{2}}{{R}_{1}} ] )}^{2}} ) \qquad ( 14 )$$

This results in an increase of the pressure with respect to the pressure in the main flow. In the same way it can be shown that the pressure at the inner radius in the corner is lower than the main pressure according to

$${P}_{1 , l} - {P}_{2} = \frac{1}{2} {ρ}_{l} {V}_{2}^{2} ( 1 - \frac{{( {R}_{2} - {R}_{1} )}^{2}}{{{R}_{1}^{2} ( Ln [ \frac{{R}_{2}}{{R}_{1}} ] )}^{2}} ) \qquad ( 15 )$$

1. A frothing device (10) suitable for being used in a beverage machine, comprising:
a) an inlet (11) for a frothing medium (12),
b) a gas inlet (13) having an opening diameter,
c) a pumping means (14), and
d) a tubing (15) connecting the aforementioned components to one another,
wherein the aforementioned components form a continuous tubing system, and
wherein, due to the pumping action of the pumping means, a negative pressure difference with respect to atmospheric pressure is accomplished throughout the whole tubing system, characterized in that the gas inlet opening is disposed at a position in said tubing system where the pressure difference with respect to atmospheric pressure is smaller than in most other positions in said tubing system.

2. The frothing device according to claim 1, characterized in that the device comprises a constriction (16) in its tubing, the latter being disposed between the inlet for the frothing medium and the pumping means.

3. The frothing device according to claim 1 characterized in that
e) the tubing comprises a corner section characterized by an angle, an inner radius, a mean radius and an outer radius, respectively, wherein
f) the gas inlet opening is disposed in the tubing wall, namely in the outer area of the tubing corner section.

4. The frothing device according to claim 1 characterized in that the gas inlet opening is disposed in the tubing wall of the inlet for the frothing medium.

5. A frothing device suitable for being used in a beverage machine, comprising:
a) an inlet for a frothing medium,
b) a gas inlet having an opening diameter,
c) a pumping means, and
d) a tubing connecting the aforementioned components to one another,
wherein the aforementioned components form a continuous tubing system, and
wherein, due to the pumping action of the pumping means, a negative pressure difference with respect to atmospheric pressure is accomplished throughout the whole tubing system, characterized in that the gas inlet opening is formed in such way that the ratio between the length of the gas duct defined by the gas inlet opening and the gas inlet opening diameter is greater than 3.

6. A method for reducing the opening diameter of a gas inlet in a frothing device suitable for being used in a beverage machine, the latter comprising:
a) an inlet for a frothing medium,
b) a pumping means, and
c) a tubing connecting the aforementioned components to one another,
wherein the aforementioned components form a continuous tubing system, and
wherein, due to the pumping action of the pumping means, a negative pressure difference with respect to atmospheric pressure is accomplished throughout the whole tubing system, characterized in that the gas inlet opening is being disposed at a position in said tubing system where the pressure difference with respect to atmospheric pressure is smaller than in most other positions in said tubing system.

7. The method according to claim 6, wherein the frothing device comprises a constriction in its tubing, disposed between the inlet for the frothing medium and the pumping means.

8. The method according to claim 6, characterized in that
e) the tubing comprises a corner section characterized by an angle, an inner radius, a mean radius and an outer radius, respectively, wherein
f) the gas inlet opening is disposed in the tubing wall, namely in the outer area of the tubing corner section.

9. The method according to claim 6, characterized in that the gas inlet opening is disposed in the tubing wall of the inlet for the frothing medium.

10. A method for reducing the opening diameter of a gas inlet in a frothing device suitable for being used in a beverage machine, the latter comprising:
a) an inlet for a frothing medium,
b) a gas inlet having an opening diameter,
c) a pumping means, and
d) a tubing connecting the aforementioned components to one another,
wherein the aforementioned components form a continuous tubing system, and
wherein, due to the pumping action of the pumping means, a negative pressure difference with respect to atmospheric pressure is accomplished throughout the whole tubing system, characterized in that the gas inlet opening is formed in such way that the ratio between the length of the gas duct defined by the gas inlet opening and the gas inlet opening diameter is greater than 3.
